(19) United States
(12) Patent Application Publication
(10) Pub. No.: US 2017/0293035 A1
(43) Pub. Date: Oct. 12, 2017

(54) Wearable Lifetime Personal High Sensitivity and Wide-Dynamic Range Measurement Apparatus and Method for Real-Time Radiation Exposure Measurement and Cancer Risk Management Due to Harmful Radiation in All Environments

(71) Applicants: Surinder Badyal, Ridgecrest, CA (US); Kenneth A. Miller, Simi Valley, CA (US); Nasir J. Zaidi, Burbank, CA (US); Bruce Levitt, Burbank, CA (US)

(72) Inventors: Surinder Badyal, Ridgecrest, CA (US); Kenneth A. Miller, Simi Valley, CA (US); Nasir J. Zaidi, Burbank, CA (US); Bruce Levitt, Burbank, CA (US)

(21) Appl. No.: 15/481,278

(22) Filed: Apr. 6, 2017

Related U.S. Application Data
(60) Provisional application No. 62/390,730, filed on Apr. 7, 2016.

(51) Int. Cl. G01T 1/02; G06F 21/32; G01T 7/12

(52) U.S. Cl. CPC G01T 1/02; G01T 7/12; G06F 21/32; G08B 21/182

(57) ABSTRACT

A dynamic, wearable low-cost, personal high-sensitivity and wide-dynamic range measurement apparatus and method provide an accurate, objective and independent device for the real-time measurement and monitoring of an individual's career or lifetime exposure to known and unknown sources of harmful ionizing radiation, for real-time radiation exposure monitoring, overexposure warning and cancer risk management due to harmful radiation in all ambient environments. The measurement apparatus and method are wirelessly interfaced to a smartphone/controller or other host computer which provide a verification device to prevent an unauthorized use, a device to time-stamp and permanently data-log measured location based data using a smartphone/GPS data, and a device to predict and warn the individual when dangerous levels are actually approached, or will likely be approached or exceeded over the entire career or lifetime of the individual, and provide an access device for real-time estimates of the individual's risk of developing cancer or other threatening disease. Also, the measurement apparatus and method provide an additional device to allow these personal radiation exposure data to be made available via the Internet, and/or cloud storage, for digital data applications such as personal electronic health records and/or for future data mining, Internet, if Things, etc., applications.

### REFERENCES CITED AND INCORPORATED BY REFERENCE IN THEIR ENTIRETY

U.S. PATENT DOCUMENTS

| | | |
|---|---|---|
| 4642463 | Feb. 1987 | Thorns |
| 4695730 | Sep. 1987 | Noda et al. |
| 4733383 | Mar. 1988 | Waterbury |
| 5132543 | Jul. 1992 | Valentine et al. |
| 5666105 | Sep. 1997 | Adler et al. |
| 6406914 | Jun. 2002 | Kaburaki et al. |

### FIELD OF THE INVENTION

The present invention relates to a measurement device and more particularly to a device which may provide lifetime exposure to cancer causing sources.

### BACKGROUND OF THE INVENTION

Cancer is a global crisis responsible for nearly 8 million deaths, and 36 million people are affected by the disease. Cancer is a leading cause of death in United States second only to heart disease. Overall career or lifetime risk of developing invasive cancer is nearly 1 in 3 for women and 1 in 2 for men. One known culprit is the accumulated exposure to harmful, ionizing radiation in the environment. Ionizing radiation overexposure is causing millions of cases of cancer and thousands of deaths yearly.

Cumulative exposure to ionizing radiation in the environment is known to cause DNA mutations that lead to cancer. Ionizing radiation comes in many different forms, for example medical radiation (x-ray, CT-scans, radiation therapy, etc.), background cosmic radiation, nuclear waste and accidents, air travel, occupational exposure, etc. Ionizing radiation is a hidden danger. You don't feel it while being exposed, the dose accumulates over time and any damage may not show up for years.

This cumulative career or lifetime exposure is a danger to occupational safety workers and the general public alike and especially to the cancer survivors who have gone through radiation therapy treatments. The chance of developing more lethal secondary cancers to this high-risk group increases with each exposure.

Today, several methods of estimating the risk of developing cancer as a result exposure to ionizing radiation are available to the general public. They require manually inputting each estimated radiation exposure into a software program which subsequently computes an estimation of cancer risk using various models. The usual method requires the individual to estimate such parameters as medical exposure, based on the number and type of medical radiological procedures the individual has ever received. All other known environmental exposures are also estimated, such as regional background (where the individual has lived and visited, and when) any airline travel (when and by which routes), etc. All these methods rely on an estimate of exposure that is averaged over some time period, route, or region. However, actual instantaneous radiation measurements reveal wide variations over time, which can dramatically affect the accuracy of the resultant cancer risk estimation. Plus, since many of these methods typically do not provide real-time measurement, radiation overexposures may not be identified until long after safe levels have already been exceeded.

Many radiation detecting devices are available today (Geiger counters or radiation survey meters are common examples that measure background sources). Devices called dosimeters record occupational exposure data, e.g., x-ray, gamma and neutron radiation, and radiation monitors record background data at specific locations over time, e.g., near nuclear power plants. Personal, portable devices are also available to the general public that typically measure alpha, beta, e.g. particle radiation, and/or x-ray, cosmic rays and gamma radiation, e.g., photon sources, in real-time and provide alarms when specified predetermined radiation levels are exceeded. These devices are sometimes referred to as personal dosimeters.

U.S. Pat. No. 7,495,224 discloses such an apparatus. It is a small, light-weight portable radiation measurement apparatus that provides accurate quantitative measurements of radiation dosage and dosage rates. This apparatus is housed in a ruggedized housing that is only about ½ the volume of a package of cigarettes, may easily be clipped to clothing or carried in a shirt pocket, and is battery powered. Included in the housing of the apparatus are a Geiger-Mueller tube, or a Geiger tube for detecting radiation, a high voltage power supply for providing power to the Geiger tube, a counting circuit for counting Geiger pulses generated by the Geiger tube, a microprocessor circuit for processing the Geiger pulses in accordance with a prescribed program to determine the dose or dosage rate to which the Geiger tube has been exposed, and a digital display that displays the dosage rates thus determined. The microprocessor program is stored in memory circuits, which is included as part of the microprocessor circuit. An audible alarm is generated whenever the dose or dosage rate exceeds a programmable threshold. The circuitry and display allow a wide range of radiation levels to be detected and displayed. Also provided is a communications port that allows necessary data, e.g., calibration coefficients or dosage data, to be transferred to and from the dosimeter circuitry.

However, these devices have several drawbacks that the present invention remedies:
1. They are not wirelessly interconnected to either smartphones that use application packages commonly in the possession of the general public, or to a centralized shared host computer.
2. They fail to guarantee that only the authorized user is being monitored since they lack password/biometric verification and permanent, time-stamped location-based data logging using smartphone GPS data.
3. They are not easily worn, and attached to clothing as readily as the traditional film badge and do not require specialized training beyond film badge and smartphone apps.
4. They are cumbersome, costly, fragile, or they lack adequate sensitivity or dynamic range. In order to have adequate sensitivity to measure background radiation, these devices either use fragile Geiger-Mueller glass tubes or electro-optical scintillators which limit dynamic range, require additional high voltage, thereby adding cost, complexity and noise-generating electronics.
5. They may lack location-based digital data-logging capability and do not contain or have access to the requisite non-destructive personal career or lifetime exposure historical information of the authorized user. Therefore, they cannot dynamically predict over-exposure threshold limits nor compute on-going cancer risk estimates over a career or lifetime.
6. They may also lack the ability to identify and account for how varying ionizing radiation dose levels and radiation source types affect the human body differently over time: For example, not being able to differentiate between potential over-exposure to harmful high-level radiation for a short interval of time versus an accumulated total exposure of the same total value acquired over a much longer period of time from lower exposure levels, and not being able to differentiate between particle and photon sources e.g., alpha, beta, gamma, x-ray, cosmic ray, etc. These variants may have significantly different biological effects on the individual.
7. They cannot be interconnected via the Internet and cloud storage to the Internet of

Things and other current and future digital applications.
8. They do not provide for manual input of known exposure data, for example, after x-rays and radiation therapy sessions, or flying over high radiation sites such as polar routes. Without these capabilities, these devices and methods cannot provide an accurate method of allowing an individual to manage real-time risk of developing cancer from exposure to harmful ionizing radiation in all environments, over the individual's career or lifetime, and allow for digital data information to be accumulated, interconnected, stored in the cloud, and made available for personal electronic health records and mined in the future, for example, using pattern recognition algorithms.

The present apparatus and method resolve all the above issues.

### SUMMARY

The present apparatus and method extends beyond the capabilities of typical devices on the market today such as the one described above. Such devices are adequate for detecting, quantifying and displaying dose rate, accumulated dose levels, sounding warning alarms when programmable thresholds are exceeded, and transferring necessary data to and from the apparatus circuitry.

### BRIEF DESCRIPTION OF THE DRAWINGS

The foregoing objects, features and advantages of the invention will become more apparent from a reading of the following description in connection with the accompanying drawings, in which:

FIG. 1 illustrates a diagram of the measuring apparatus with sensor device housing;

FIG. 2 illustrates the sensor housing of the present invention;

FIG. 3 illustrates a cross-sectional view of the sensor housing of the present invention;

FIG. 4 illustrates a circuit diagram of the measuring device of the present invention.

### DESCRIPTION OF THE INVENTION

The present invention generally relates to an exclusive-use personal, portable measurement apparatus and a method that provide an accurate, objective and an independent device for the real-time measurement and monitoring of an individual's exposure to known and unknown sources of harmful ionizing radiation in the ambient environment, over a career or lifetime. The wearable apparatus incorporates high-sensitivity, wide-dynamic range and an all-solid-state electronics design for low-cost, ruggedness, wide sensitivity range and compact size. The apparatus sensor device may include a plurality of independent sensor devices, where each device including a password and/or biometrics protection against unauthorized usage. The sensor devices have sufficient sensitivity to measure dynamic background radiation levels and accumulate radiation exposure measurements over a career or lifetime and communicate exposure data to a handheld computer such as a smartphone and/or central computer by tethered and/or wireless means using integral software. The apparatus and method also provide a device to predict and warn the individual when dangerous levels are currently, or will likely be approached or exceeded over both the short term and over the entire career or lifetime of the individual. Further, by accumulating and archiving radiation exposure data over the individual's career or lifetime by both direct measurement and/or manual data input, the apparatus and method provide the device for real-time estimates of the individual's risk of developing cancer as a result accumulated exposures, thereby providing the ability of empowering the individual to manage the risk of developing cancer due to exposure to harmful radiation in all ambient environments. Also, the measurement apparatus and method allow these personal radiation exposure digital data to be made available for digital data applications such as electronic personal health records or data mining via interconnecting over the Internet and through cloud storage.

The present invention includes various embodiments for a dynamic, wearable low-cost, personal high-sensitivity and wide-dynamic range measurement apparatus and method that provide an accurate, objective and independent device for the real-time measurement and monitoring of an individual's career or lifetime exposure to known and unknown sources of harmful ionizing radiation, for real-time radiation exposure monitoring, overexposure warning and cancer risk management due to harmful radiation in all ambient environments. The measurement apparatus and method are wirelessly interfaced to a smartphone or other host computer which provide a verification device to prevent unauthorized use, a device to time-stamp and permanently data-log measured location based data using smartphone/GPS data, and a device to predict and warn the individual when dangerous levels are, or will likely be approached or exceeded over the entire career or lifetime of the individual, and provide the access device for real-time estimates of the individual's risk of developing cancer. Also, the measurement apparatus and method provide an additional device to allow these personal radiation exposure data to be accumulated, interconnected, and made available via the Internet, and/or cloud storage, for digital data applications such as personal electronic health records, Internet of Things and for future data mining applications.

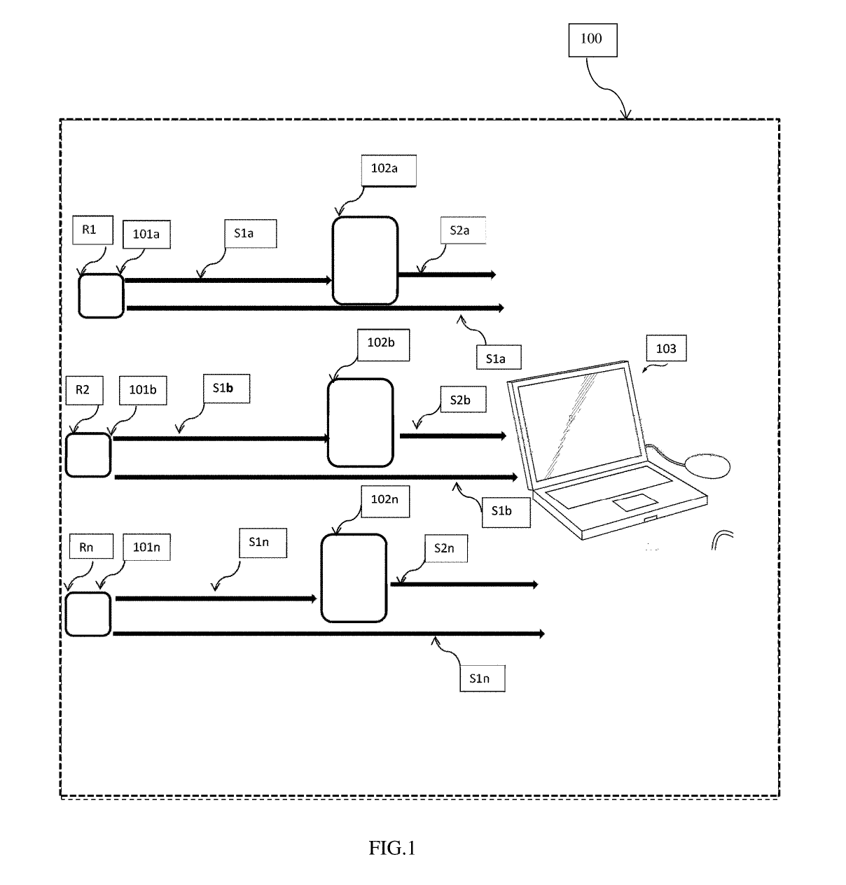

FIG. 1 is a block diagram of a measuring apparatus with sensor device housings 101a, 101b, 101n wirelessly connected;

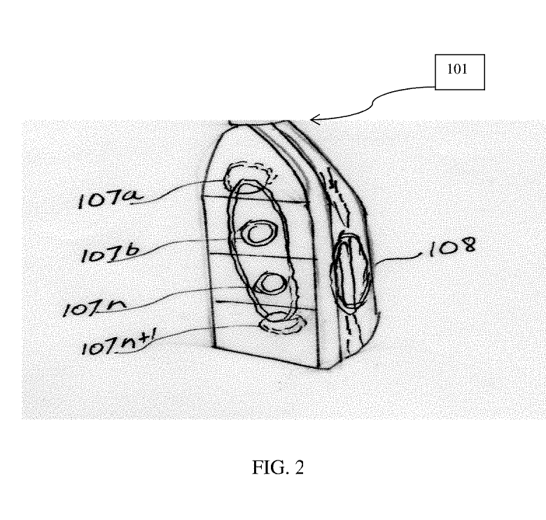

FIG. 2 is a perspective view of the sensor device housings with a partially cut away sectional view of sensor detectors and noise shield;

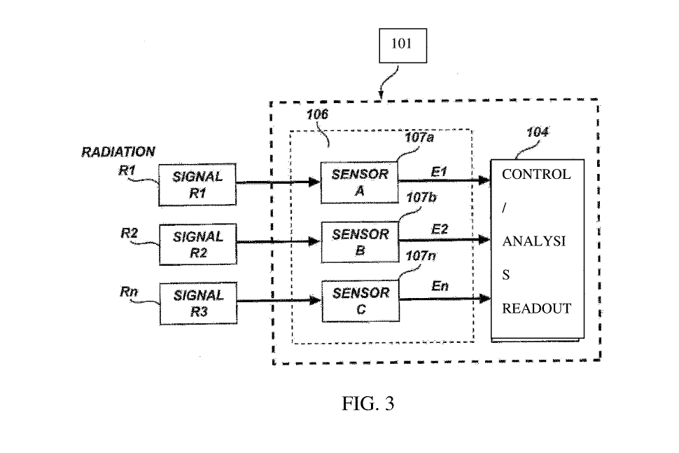

FIG. 3 is a detailed block diagram of circuitry sensor device measuring apparatus, showing analog signal flow of the present invention;

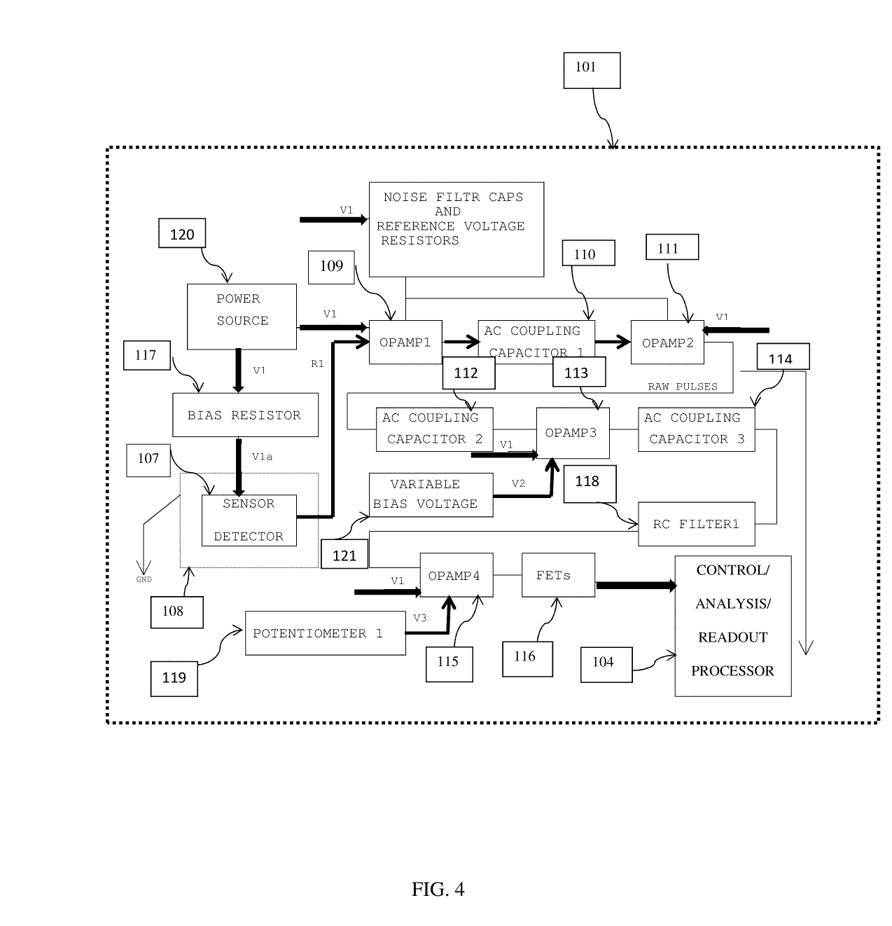

FIG. 4 is a detailed block diagram of analog circuitry of sensor device measuring apparatus and the method to obtain wide dynamic range and optimize signal-to-noise levels.

The apparatus and method includes:

One or more small, dynamic sensor devices to detect a wide-dynamic range of photon/and or particle radiation levels in all environments being enclosed in a small wearable, housing with all-solid-state electronics that can be easily worn, or attached to clothing, or included within wearable smart clothing and wirelessly interfaced to a smartphone or other host computer, controlled by custom application software with a device for Internet and/or intranet access.

A new measurement method that optimizes the sensor sensitivity and dynamic range that incorporates a sensor that is shielded from noise sources, and analog circuitry that allows the sensor to operate under wide range of supply voltages and varying analog signal levels, and a digital processor that applies digital calibration scaling factors, a device for permanent, location-based data logging using smartphone/GPS data, alarm threshold, a device for apparatus operation and a device for wireless interfacing, interconnecting and updating.

Additionally, analog amplifiers, pulse shaping circuits, digital processor, permanent and temporary memory, status displays, real-time clock, battery and power supply circuits are also included in the sensor device housing.

The present invention provides the following:
1. The apparatus and method to wirelessly interconnect to smartphones and/or to a centralized host computer thereby accommodating custom application packages and updates.
2. Each sensor device is protected against unauthorized use by a smartphone password/biometric verification and a permanent, time-stamped location-based data logging using GPS data.
3. The sensor apparatus is wearable and easily attachable, or included within clothing as readily as a traditional film badge.
4. The wearable sensor device apparatus and method are as easy to use as passive film badges and smartphone applications.
5. The sensor device apparatus may be one or multiple units and may include a plurality of detector elements sensitive to different kinds and/or levels of ionizing radiation sources.
6. The wearable sensor apparatus is small, light-weight, inexpensive, all-solid-state, and rugged. The wearable sensor apparatus has substantial sensitivity to measure low-level background radiation levels with extremely wide dynamic range and is accomplished by shielding, adjusting amplifier gains and back-biasing the detector of the sensor device for optimal signal-to-noise ratios under varying battery source voltage levels and analog signal levels. This configuration avoids both fragile Geiger-Mueller glass tubes, and electro-optical scintillators which require added cost, complexity and noise-generating high voltage electronics.
7. Permanent time-stamped, location-based data logging using GPS data provides a data recording device for exposure levels, time of exposures and exposure locations, and provides a further device to identify and account for how various types and levels of ionizing radiation affect the human body differently over time.
8. Wireless interconnection between the sensor device apparatus, a smartphone/controller, and via the Internet and cloud storage, provides a device to access digital data information for personal electronic health records, the Internet of Things and future data mining applications, for example, using pattern recognition algorithms.
9. Use of a smartphone provides a convenient device to manually input known exposure data, for example, after x-rays and radiation therapy sessions, or flying over high radiation sites such as polar routes.

Reference now should be made to the drawings.

FIG. 1 is a block diagram of a measuring apparatus 100 with sensor device housings 101a, 101b, 101n of remote R1, R2, . . . Rn being wirelessly connected to smartphone control and readout housings 102a, 102b, 102n by digital signal S1a, S1b, S1n, and either tethered or wirelessly connected to host computer 103; a smart phone control and readout housing 102a, 102b 102n outputs a second digital signal S2a S2b S2n to the host computer 103.

FIG. 2 is a perspective view of previously the sensor device housings 101a, 101b, 101n (collectively shown as 101) with a partially cut away sectional view of sensor detectors 107a, 107b, 107n, 107n+1 which may be positioned within a cavity of the sensor device housing 101 and which may be connected to the exterior of the sensor device housing 101 by a sensor passageway (not shown) and noise shield 108 to provide insulation from exterior noise preventing the noise from reaching the sensor detectors 107a, 107b 107n and 107n+1 and positioned on the exterior of the sensor device housing 101.

FIG. 3 is a detailed block diagram of circuitry sensor device measuring apparatus 101a, 101b, 101n showing analog signal flow;

FIG. 4 is a detailed block diagram of the analog circuitry of sensor device measuring apparatus 101a, 101b, 101n and the new method to obtain wide dynamic range and optimize signal-to-noise levels.

Benefits

The present invention is a wearable dynamic compact portable, all-solid state, high-sensitivity and wide-dynamic range, password protected, personal measurement apparatus and method system which provides an accurate, objective and independent device for the real-time measurement and monitoring of an individual's career or lifetime exposure to sources of harmful ionizing radiation in all ambient environments.

The apparatus and method may provide a device for real-time estimates of the individual's risk of developing cancer as a result accumulated exposures.

The apparatus and method may provide a device to predict and warn the individual when dangerous levels are, or will likely be, approached or exceeded over the entire career or life of an individual user.

Further, by permanently accumulating and archiving radiation exposure data over the individual's entire career or lifetime by direct measurement and manual data input, the apparatus and method may provide a device for real-time estimates of the individual's risk of developing cancer as a result of all accumulated exposures, thereby may provide an added way of empowering the individual to manage the risk of developing cancer due to exposure to harmful radiation in all environments.

An interfacing device allows digital data to also be made available via the Internet for data base applications such as cloud storage, personal electronic health records or future data mining and Internet of Things.

The apparatus and method system provide a device for password and/or biometric authentication to prevent unauthorized use.

The apparatus may include a sensor device, or plurality of sensor devices, as a device to measure radiation in real-time from singular and/or multiple ionizing radiation sources in all ambient environments and as a device to generate sensor data in response to the radiation from all radiation sources in the surrounding environment of the user. The sensor device may include singular or multiple sensor detectors, amplifiers with novel measurement methods, status and warning displays and alarms and a processor with permanent and temporary memory, power supply circuitry and battery.

The sensor device may be included within, and either attached to, or preferably wirelessly connected to, a host computer such as a smartphone, that may also include specific application and calibration software and a device for permanent data-logging location-based GPS data, and an input device for manual exposure data entry using the smartphone or host computer display/keypad.

The sensor device and/or host processor may process the sensor data to obtain a predictive time or level when the sensor data will exceed the predetermined sensor data threshold, and the predetermined sensor data level may be further updated from a remote device or entered manually via the display/keypad of the host computer or smartphone.

The predetermined sensor data may include maximum threshold sensor data which has the ability to activate warning alarms, and minimum threshold sensor data which may also provide a device to activate a “wake up and take data” mode.

The sensor device and/or host processor may provide a device to compute and display estimated cancer risk based upon predetermined sensor data and predictive models.

The sensor device and/or host processor may include a device for replaceable software from a remote computer or via the Internet.

The sensor device and/or host processor may have a device to update personal career or lifetime radiation exposure data from both the sensor device data and manually entered exposure data, e.g., from a medical radiological procedure, and/or remotely obtained exposure data.

The sensor devices and/or host processors may provide a device to be wirelessly interconnected to each other via the internet and cloud storage as a device of accumulating digital data for location-based data logging using GPS data, personal electronic health records and historical comparative data analysis and for future data mining and Internet of Things applications.

Referring to FIG. 1, sensor device housing 101a, 101b, 101n is attached to the body, exterior clothing, included within wearable smart clothing, or is in the proximity of the user and either smartphone 102a, 102b, 102n, or host computer 103.

Now referring to FIG. 2, radiation is absorbed by sensors 107a, 107b, 107n, 107n+1 that are shielded from noise sources by noise shield 108.

Now referring to FIG. 3, radiation signal R1, R2, Rn generated by a radiation source (not shown) is detected by respective radiation sensor detector 107a, 107b, 107n resulting in analog signal E1, E2, En. Said analog signal E1, E2, En is input, digitized and processed by sensor device control/analysis/readout processor 104.

Now referring again to FIG. 1 the digital outputs from said sensor device 101a, 101b, 101n are digitized signals, S1a, S1b, S1n, which are wirelessly sent to said smartphone/controller housing 102a, 102b, 102n and/or to the host computer 103.

Now referring to FIG.4, to get an improved dynamic range of the sensor detector 107, the sensor detector 107 is shielded for noise sources by the noise shield 108;

To optimize signal-to-noise ratio, bias voltage V1 from battery power source 120 is applied to op amps (operational amplifier) 109 and 111 to bring the the R1 signal level to the normal operating range of the the op amps 109, 111.

RC filter 118, the AC coupling capacitors 112 and 114 and the op amps 113 and 115 shape the raw radiation pulses R1 such that they can be counted by the control/analysis/readout processor 104.

Adjustable bias voltage V2 from variable bias voltage source 121 is added to the op amp 113 to bring the input signal levels to the normal op amp operating range.

The op amp 113 is an inverting type. Gain of the op amp 113, the value of bias resistor 117, and the AC coupling capacitor 110 are set to minimize noise.

The op amp 115 is configured as a comparator which is used to set detection sensitivity level V3 and is adjusted by potentiometer 119.

Dual FETs 116 are used to convert the signal pulses to voltage levels compatible with the voltage levels required by the the control/analysis/readout processor 104.

Final calibration is accomplished by adjustment of the detection sensitivity level V3 by potentiometer 119 to a known radiation calibration source.

By using the power supply voltage V1 from the power source 120 for the sensor detector 107, bias voltage source V1a and the V1 to supply voltage to the op amps 109, 111, 113 and 115 instead of a separate reference voltage in a the normal bias voltage configuration, any changes in the battery power source 120 effects the V1 level and resultant noise levels, which thereby also affect detection threshold levels of the radiation signal R1 by the sensor detector 107. The commonly supplied voltage V1 thereby keeps everything floating in balance and also allows the apparatus to operate normally from the battery power source 120 of the voltage level V1 over a range of the V1 voltage levels from more than 6 vdc to under 3 vdc.

Again, the shaped pulses are digitized and processed by the control/analysis/readout processor 104 positioned in the the sensor device apparatus 101 housing.

Now again referring again to FIG. 1, digital signals S1a, S1b, S1n from the sensor device apparatus 101a, 101b, 101n housing are transmitted to said smartphone/control device housing 102a, 102b, 102n.

The sensor device apparatus may be directly worn, or easily attached to clothing, or included within wearable smart clothing. The sensor apparatus and method are as easy to use as a traditional film badge and smartphone applications. A device with adequate sensitivity to measure low-level background radiation levels is formed by shielding and back-biasing the sensor device's solid-state detector and adjusting amplifier gain for optimal signal-to-noise ratios by using the same voltage reference. A device is provided to automatically accommodate a wide dynamic range of ambient environment radiation levels, from low-exposure background levels to potential high-exposure levels from a disaster. Permanent, time-stamped location-based data logging, using GPS data, provides a device to identify, locate and quantify how exposure to various types and levels of ionizing radiation affect the human body differently over varying time intervals. Wireless interconnection between the sensor apparatus, a smartphone/controller and via the Internet and cloud storage, provide an access device to interconnect to digital information data bases. This apparatus and measurement method also provide a predictive device to estimate the risk of developing cancer in real-time based on actual measured data as well as a manual entry device for entering known exposure data, and a warnings device when predetermined threshold levels are exceeded or are predicted to be exceeded.

What is claimed:

1. A wearable dynamic personal apparatus and measurement system, comprising:
a wireless device to wirelessly interconnect to at least one of a smart phone, a centralized host computer or the Internet having advanced custom application packages;
the wireless device including a sensor device being protected against unauthorized use by at least one of a password/biometric verification and a permanent, time-stamped location-based data logging using GPS data, for an individual's career or lifetime exposure history; wherein the sensor device is wearable and enclosed in a housing and incorporates an all-solid-state electronic design; the sensor device apparatus and includes a plurality of detector elements responsive to different types and levels of ionizing radiation sources.

2. A wearable dynamic apparatus and measurement system as in claim 1, wherein the system includes an interconnection device to wirelessly interconnect to at least one of a smart phone or a centralized host to incorporate advanced custom application packages.

3. A wearable dynamic personal portable apparatus and measurement system as in claim 1, wherein the sensor device apparatus includes a plurality of detector elements sensitive to different types and levels of ionizing radiation sources.

4. A wearable dynamic personal portable apparatus and measurement system as in claim 1, wherein the system includes a password/biometric verification device to protect the sensor device from unauthorized use.

5. A dynamic personal, portable apparatus and measurement system as in claim 1, wherein the sensor device apparatus is wearable and enclosed in the housing and incorporates an inexpensive, all-solid-state electronic design.

6. A wearable dynamic personal, portable apparatus and measurement system as in claim 1, wherein the system includes an accommodation device two automatically accommodate a range of ambient environment radiation levels, from low-exposure background levels to potentially high-exposure disaster levels.

7. A wearable dynamic personal, portable apparatus and measurement system as in claim 6, wherein the system includes a device to dynamically adjust the sensitivity of the sensor device and the gain of an analog amplifier based on varying a supply voltage level and an analog signal level.

8. A wearable dynamic personal, portable apparatus and measurement system as in claim 1, wherein the system includes a device to detect, identify, quantify, monitor, display and permanently archive harmful ionizing radiation data levels from a source in the user's ambient environment.

9. A wearable dynamic personal, portable apparatus and measurement system as in claim 1, wherein the system includes a predictive device to estimate the risk of developing a disease in real-time responsive to sensor measured data and manually entered data and a warning device to initiate a warning when either a lifetime predetermined threshold level is exceeded or a predicted threshold level is exceeded.

10. A wearable dynamic personal, portable system as in claim 1, wherein the system includes a digital interfacing and interconnecting device to allow personal radiation exposure data to be made available for external digital data applications.
